(19) United States
(12) Patent Application Publication
(10) Pub. No.: US 2020/0078826 A1
(43) Pub. Date: Mar. 12, 2020

(54) MECHANISM FOR EXCHANGING COMPLIANT MEMBERS OF VIBRATING SCREENS

(71) Applicant: Johnson Crushers International, Inc., Eugene, OR (US)

(72) Inventors: Trevor Rose, Philomath, OR (US); Wills Boothe, Veneta, OR (US)

(73) Assignee: Johnson Crushers International, Inc., Eugene, OR (US)

(21) Appl. No.: 16/566,211

(22) Filed: Sep. 10, 2019

Related U.S. Application Data
(60) Provisional application No. 62/729,604, filed on Sep. 11, 2018.

(51) Int. Cl. B07B 1/44; B07B 1/46

(52) U.S. Cl. CPC B07B 1/44; B07B 1/46; F16F 2238/02; F16F 2230/46; F16F 2226/04

(57) ABSTRACT

An apparatus for use in replacing a compliant member of a vibratory screen assembly. In supporting the vibratory screen assembly, the compliant member is compressed between a screen base and a contact plate that is mounted on a screen frame of the vibratory screen assembly and potential energy is stored by the compliant member as a result of the compression. The apparatus includes an exchanging plate and connectors that hold the exchanging plate at a selectively adjustable distance away from the contact plate. The potential energy stored by the compliant member may be decreased by increasing the distance between the exchanging plate and contact plate by adjusting the connectors. The compliant member may be safely removed and exchanged by eliminating all compression in the compliant member using the exchanging plate.

### CROSS-REFERENCE TO RELATED APPLICATIONS

This application claims the benefit of U.S. Provisional Patent Application No. 62/729,604, filed on Sep. 11, 2018 and entitled MECHANISM FOR EXCHANGING COMPLIANT MEMBERS OF VIBRATING SCREENS, which is incorporated herein by reference in its entirety.

### FIELD

The invention relates generally to vibratory screens. More particularly, the present invention relates to a mechanism for exchanging compliant members of vibrating screen.

### BACKGROUND

With initial reference to FIGS. 1 and 2, there is provided a conventional vibratory screen assembly 100, which may be used to classify and separate material into two or more differently-sized products. A typical vibratory screen assembly 100 is comprised of one or more screen decks 102 which attach to a screen frame 104 that includes a pair of side plates 106. Each screen deck 102 includes a sizing medium 108 such as wire cloth. The sizing media 108 has openings 110 that dictate the largest sized material particle that can pass through the media. An impulse mechanism (not shown) is provided to generate vibrational motion and to impart such motion to the screen deck(s) 102 of the screen assembly 100. This vibration is design to stratify the material as it flows across the media 108 and to expose the material particles to the media openings 110.

Material to be classified by particle size flows across the length of each screen deck 102, and generally, at least some of it passes through the sizing media 108 as the impulse mechanism vibrates the screen deck 102. The vibrations imparted to the screen deck 102 cause material small enough to pass through the media 108 to pass through to a lower screen deck or transfer chute or conveyor. It also helps to convey the material across the screen deck 102 and prevents material build-up on the sizing media 108.

The screen frame 104 is supported by compressible compliant members 112, which are commonly formed from metal or elastomer springs, which isolate the screen frame 104 from a screen base 114. A compliant member 112 is positioned below each of one or more bracket assemblies 116 located on or near each corner of screen frame 104. Bracket assemblies 116 include a back plate 118 to which are attached a pair of spaced apart side stiffeners 120. A stationary contact plate 122 is fixedly attached to the back plate 118 and extends between and is connected to a bottom end of the side stiffeners 120. Bracket assemblies 116 are configured to transfer forces between the compliant members 112 and the side plates 106. The compliant members 112 are configured to compress as a compression force, such as the weight of screen frame 104 or a vibrational force, is applied to them and to decompress as the compression force is removed or is eliminated. Compliant members 112 are configured to compress between the base surface 114 and the contact plate 122. Compliant members 112 compress to an equilibrium point, where the downwardly-directed force (e.g., the weight of screen frame 104) is equivalent to the combined upwardly-directed forces of all the compliant members. The number of compliant members 112 is dependent on the mass of the screen frame 104 and the stiffness of the compliant members 112.

At times, compliant members 112 may require replacement due to wear or to change the stiffness of the vibratory screen 100, or for other reasons. Typically, when beginning the exchange process, compliant members 112 are under compression due to the weight of the screen frame 104. The compliant members 112 store potential energy when compressed and an uncontrolled release of that energy could cause serious injury or damage. Thus, in order to safely exchange compliant members 112, the potential energy should be released prior to beginning the exchange process.

One conventional method for releasing the potential energy stored in the compliant members 112 is to convert the stored potential energy to gravitational potential energy by raising the screen frame 104 off of some or all of the compliant members. Raising the screen frame 104 allows the compliant members 112 to decompress, at which point the compliant members can be safely exchanged. Frequently, the lifting device used in raising the screen frame 104 is a counterweighted crane or a mechanical jack. Such lifting devices may require several operators working in tandem to complete the task of exchanging the compliant members 112. These lifting devices also may not be readily available at the locations which the vibratory screen assemblies 100 are located. Consequently, replacing compliant members 112 in a screen frame 104 according to conventional methods may require significant down time as the proper equipment is re-located. Additionally, raising a screen frame 104 with respect to screen base 114 is inherently dangerous due to the potential of the screen frame falling.

What is needed, therefore, is a method and apparatus that enables compliant members to be quickly and easily swapped without requiring raising the screen frame.

### Notes on Construction

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY

The above and other needs are met by an apparatus for use in replacing a compliant member of a vibratory screen assembly. As described above, when supporting the vibratory screen assembly, compliant members are compressed between a base surface and a movable contact plate of the vibratory screen assembly and potential energy is stored by the compliant members as a result of the compression. In a preferred embodiment of the present invention, the apparatus includes an exchanging plate and connectors that hold the exchanging plate at a selectively adjustable distance away from the contact plate. The potential energy stored by the compliant member may be decreased by increasing the distance between the exchanging plate and contact plate by adjusting the connectors. The compliant member may be safely removed and exchanged by eliminating all compression in the compliant member using the exchanging plate.

Certain preferred embodiments of the present invention provide a screen assembly system. The system includes a vibratory screen assembly configured to classify and separate material into two or more differently-sized products based on the size of the material. Bracket assemblies mounted to the vibratory screen assembly include a movable contact plate and a compliant member. The compliant member compresses between a base surface and the movable contact plate when supporting the screen assembly. The compliant member stores potential energy as a result of that compression. The system also includes exchanging plates and connectors. The connectors connect one of the exchanging plates to one of the contact plates and hold the exchanging plate at a selectively adjustable distance away from the contact plate. The potential energy stored by the compliant member may be increased by decreasing the distance between the contact plate and the exchanging plate. Increasing the potential energy stored in one of the compliant members reduces the potential energy stored in the other compliant members. Conversely, the potential energy stored by the compliant member may be decreased by increasing the distance between the contact plate and the exchanging plate. Decreasing the potential energy stored in one of the compliant members increases the potential energy stored in the other compliant members. The potential energy stored in a compliant member may be reduced entirely until the compliant member is no longer compressed and, at that point, the compliant member may be safely removed. Preferably, the bracket assemblies are arranged and configured such that, after the potential energy stored by the compliant member of at least one bracket assembly is decreased entirely, the vibratory screen assembly can be entirely supported by the remaining bracket assemblies.

A preferred embodiment of the present invention provides a method for removing a compliant member from a vibratory screen assembly. The method includes the steps of providing a vibratory screen assembly having a plurality of bracket assemblies, connecting a movable contact plate to each bracket assembly at a selected vertical position such that the contact plate is prevented from moving vertically, and supporting the vibratory screen frame above a base surface by compressing compliant members between the base surface and each of the contact plates. Potential energy stored by the compressed compliant members is equivalent to the weight of the frame such that the frame is located at a first equilibrium vertical position. The method further includes the steps of removably connecting an exchange plate to a selected one movable contact plate at a selectively adjustable distance via one or more connectors and disconnecting the selected one movable contact plate from the bracket assembly such that the contact plate can move vertically within the bracket assembly. The method further includes the steps of increasing the distance between the exchange plate and the selected one movable contact plate until the compliant member is decompressed, removing the decompressed compliant member from between the base surface and the selected one movable plate, and supporting the vibratory screen frame above the base surface by compressing the remaining compliant members between the base surface and the contact plates. Potential energy stored by the remaining compressed compliant members is equivalent to the weight of the screen frame such that the screen frame is located at a second equilibrium vertical position that is different from the first equilibrium vertical position.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a perspective view depicting a conventional screen assembly including compliant members;

FIG. 2 is detail view of a bracket assembly and the compliant members of FIG. 1 enclosed within a circle identified by the letter “A”;

FIG. 3 is a perspective view of removable exchanging plates according to an embodiment of the present invention;

FIG. 4 is a top plan view illustrating exchanging plates positioned around a compliant member in a screen assembly according to an embodiment of the present invention;

FIG. 5 is a front elevation view of a compliant member supporting a bracket assembly according to an embodiment of the present invention, showing the compliant member compressed to an equilibrium point;

FIG. 6 is a front elevation view of the bracket assembly of FIG. 5 with exchanging plates positioned around the compliant member;

FIG. 7 is a front elevation view depicting the bracket assembly of FIGS. 5 and 6 with connectors partially removed from a contact plate and the compliant member partially decompressed;

FIG. 8 is a front elevation view depicting the bracket assembly of FIGS. 5-7 with connectors almost entirely removed from contact plate and the compliant member fully decompressed.

FIG. 9 is a front elevation view of a bracket assembly with a permanently attached exchange plate according to an alternative embodiment of the present invention;

FIG. 10 is a bottom perspective view of the bracket assembly of FIG. 9;

FIG. 11 is a front elevation view of a screen assembly having a height retention device according to an embodiment of the present invention; and

FIG. 12 is detail view of a bracket assembly and the height retention device of FIG. 11 enclosed within a circle identified by the letter “B”.

### DETAILED DESCRIPTION

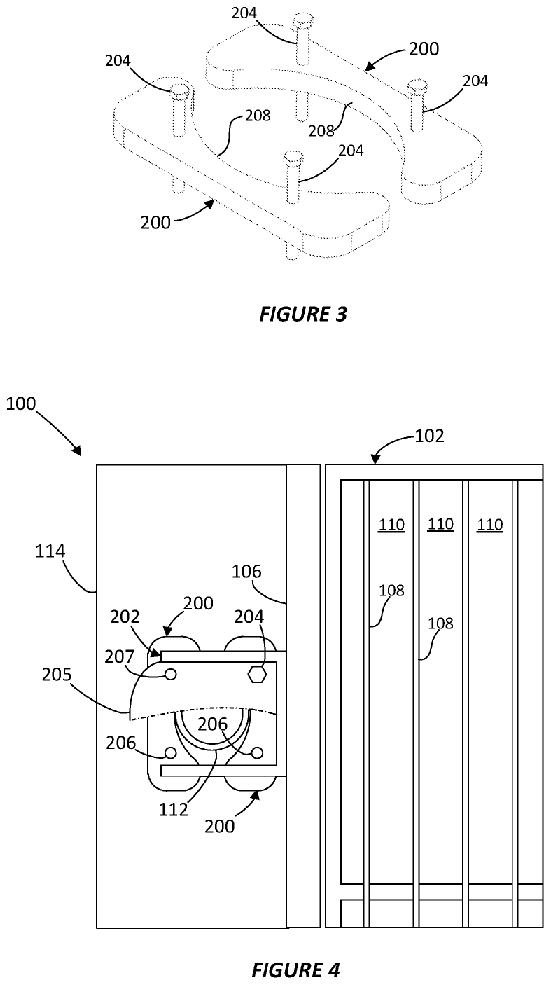

Referring now to FIGS. 3 and 4, there is provided a pair of removable exchange plates 200 and a modified bracket assembly 202 for use in exchanging compliant members 112 of a vibrating screen frame 104 according to an embodiment of the present invention.

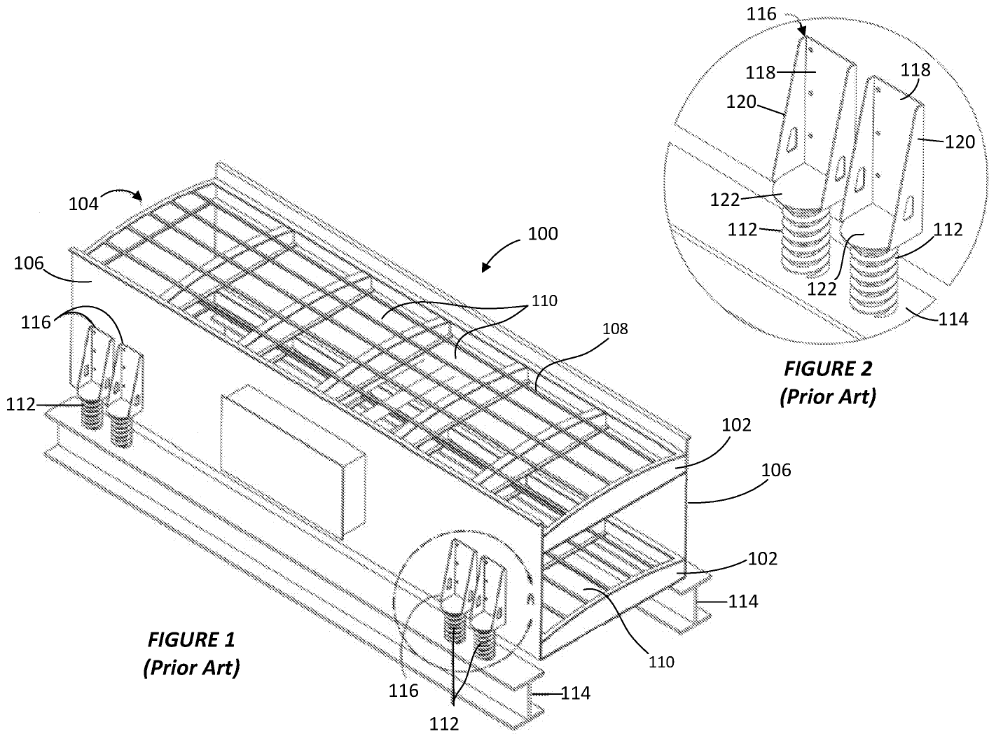

Like bracket assembly 116 (shown in FIGS. 1 and 2) bracket assembly 202 includes a back plate 201 joined between a pair of side stiffeners 203. Bracket assembly 202 also includes a movable contact plate 205 that is positioned between side stiffeners 203. However, unlike bracket assembly 116, the contact plate 205 of bracket assembly 202 is not fixedly connected to either the back plate 201 or either of the side stiffeners 203. Instead, contact plate 205 is free to move vertically within a vertically-oriented slot formed by the back plate 201 and the side stiffeners 203.

Additionally, in preferred embodiments, exchange plates 200 are removably attached to the bracket assembly 202 using a plurality of threaded connectors 204. Connectors 204 are preferably inserted through openings 207 formed in contact plate 205 and corresponding openings 206 formed in each of the exchange plates 200 and then held securely by a nut (not shown). These aligned openings 207, 206 are shown best in FIG. 4, where a portion of the contact plate 205 is shown positioned within bracket assembly 202. Alternatively, one or both of openings 207, 206 may be threaded such that connectors 204 may be held securely without the use of a nut.

By connecting exchange plates 200 to contact plate 205 with connectors 204, the compression in compliant member 112 mounted to a vibrating screen frame 104 may be relieved in a controlled, gradual fashion and without requiring the vibrating screen assembly to be lifted. Relieving this compression without lifting the vibrating screen frame 104 enables the compliant member 112 to be exchanged more easily and in a much safer and faster manner than was previously possible.

When in use, exchanging plates 200 are preferably placed on opposing sides of the compliant member 112 (e.g., front and back) and are sized and configured to substantially surround the compliant member. Preferably, the plates 200 are sized to fit between the compliant member 112 and the side plate 106 of the screen frame 104. While a single exchange plate 200 could be used, the installation process is simplified using a pair of separate plates, as shown. Each plate 200 preferably has a curved inner face 208 (FIG. 3) that generally follows the curvature of the compliant member 112. In this case, compliant member 112 is a helical spring having a diameter (when viewed from one end) and the curved inner face 208 has a diameter equal to or greater than the diameter of the compliant member. The plates 200 are preferably initially spaced slightly vertically below the bottom end of the bracket assembly 202. Connectors 204 are passed through contact plate 205 and each exchanging plate 200 and are then secured with nuts. To decrease the distance between the contact plate 205 and exchanging plate 200, the nut is tightened. Conversely, to increase the distance between the contact plate 205 and exchanging plate 200, the nut is loosened.

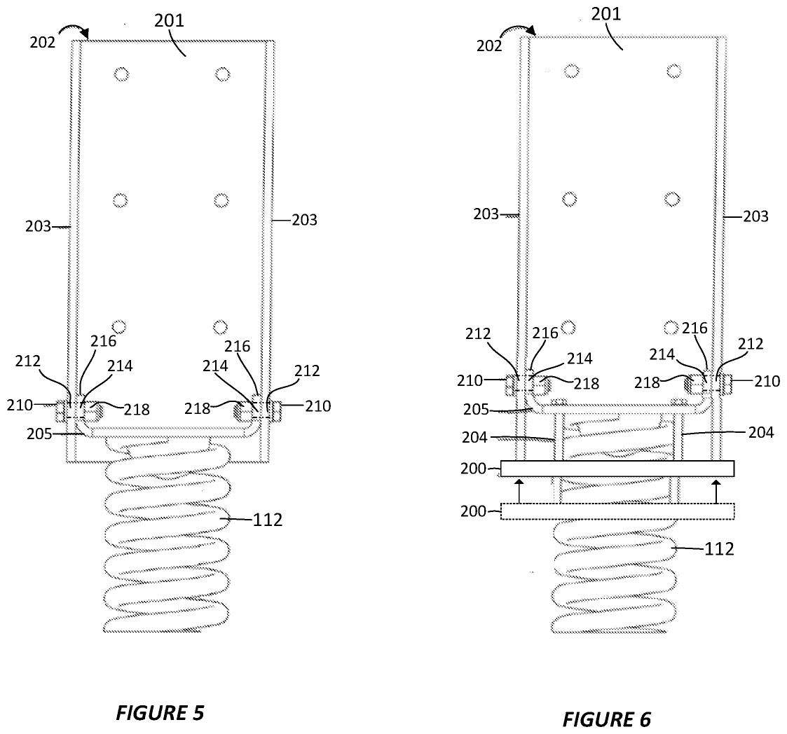

With reference now to FIG. 5, contact plate 205 is preferably removably attached to and between the side stiffeners 203 with fasteners 210. Fasteners 210 may be passed through first openings 212 in side stiffeners 203 and then through corresponding second openings 214 in upwardly-curved and vertically disposed left and rights ends 216 of contact plate 205 (or vice versa). The threaded ends of the fasteners 210 are retained within the bracket assembly 202 by a nut 218. In alternative embodiments, at least one of opening 212 or opening 214 is threaded and threaded ends of the fasteners 210 may be threaded into the opening to connect the side stiffeners 203 with the contact plate 205.

The bracket assembly 202 of FIG. 5 is shown in its normal operating configuration. In this configuration, the compliant member 112 is compressed by the weight of the screen frame 104 and, due to that compressive force, if fasteners 210 were removed from openings 212, 214, the compliant member 112 would decompress quickly and the contact plate 205 could be carried suddenly upwards by the top of the compliant member with respect to the back plate 201 and side stiffeners 203. Put differently, if fasteners 210 were removed from openings 212, 214, the screen frame 104 could fall suddenly with respect to the screen base 114. For that reason, attempting to remove the compliant member 112 or the fasteners 210 from openings 212, 214 in this configuration would be quite dangerous. Thus, as mentioned above, in order to safely exchange compliant members 112, the potential energy must be released to avoid an uncontrolled release of the built up potential energy.

Referring to FIG. 6, exchanging plates 200 are placed on opposing sides of the compliant member 112 (e.g., front and back). The plates 200 may be initially spaced slightly vertically below the bottom end of the bracket assembly 202. Connectors 204 removably connect contact plate 205 to exchanging plates 200. The connectors 204 may be fixed by a nut (or other suitable fixing mechanism) or may be threaded into either the contact plate 205 or the exchanging plates 200. Preferably, this connection prevents the exchanging plates 200 from moving towards or further away from the contact plate 205 when such movement is not desired. The distance between the exchanging plate 200 and the contact plate 205 is limited to the length of the portion of the connectors 204 that connect them together. As such, the distance between the exchanging plate 200 and the contact plate 205 is fixed and preferably is prevented from increasing or decreasing by connectors 204. As the nut is threaded further onto the connectors 204 (or connector is threaded further into the exchanging plate 200 or contact plate 205), the exchanging plate is drawn towards the contact plate and into contact with the bottom of bracket assembly 202. In this particular embodiment, the exchanging plates 200 contact the bottom end of side stiffeners 203 and back plate 201. This contact prevents the exchanging plate 200 from moving further upwards. On the other hand, as the nut is threaded off of the connectors 204 (or connector is threaded out of the exchanging plate 200 or contact plate 205), the exchanging plate is separated from the contact plate.

Once the exchanging plate 200 has been brought into contact with the bracket assembly 202, the fasteners 210 can be removed from both the side stiffeners 203 and the contact plate 205 by the operator. Removing the fasteners 210 disconnects the contact plate 205 from the bracket assembly 202, which allows the contact plate to move vertically with respect to the bracket assembly. More particularly, the contact plate 205 can move vertically within the vertical slot defined by the back plate 201 and the side stiffeners 203. This vertical movement is guided by the slot and the positioning of the contact plate 205 with respect to the bracket assembly 202 is determined by the connectors 204.

The force of the weight of the screen frame 104 is transmitted through the bracket assembly 202 downwards onto the exchanging plates 200. That force is then carried through connectors 204 up to contact plate 205. Finally, the force is then transmitted down to compliant member 112 via contact plate 205. Thus, the weight of the screen frame 104 is still borne (i.e., indirectly) by the compliant members 112, even though the bracket assembly 202 is not rigidly connected to the contact plate 205. Importantly, since the screen frame 104 is at the equilibrium point (i.e., the point where the entire weight of screen frame 104 is borne by the compliant members 112), the compliant members do not compress further when fasteners 210 are removed; rather, the compliant members 112 are already fully compressed under the weight of the screen frame 104.

Since the contact plate 205 is no longer mounted to the bracket assembly 202, the contact plate can be moved upwards between side stiffeners 203 if the compliant member 112 decompresses. Similarly, the contact plate 205 can be moved downwards between side stiffeners 203 if the compliant member 112 compresses (i.e., if connectors 204 were tightened further). However, when the fasteners 210 are first removed, the contact plate 205 remains stationary. The contact plate 205 does not move because the length of the compliant member 112 remains fixed by the connectors 204 connecting the contact plate to the exchanging plate 200 and by contact between the exchanging plates 200 and bracket assembly 202. As such, the compliant member 112 does not compress or decompress and the position of the contact plate 205 within the bracket assembly 202 remains fixed.

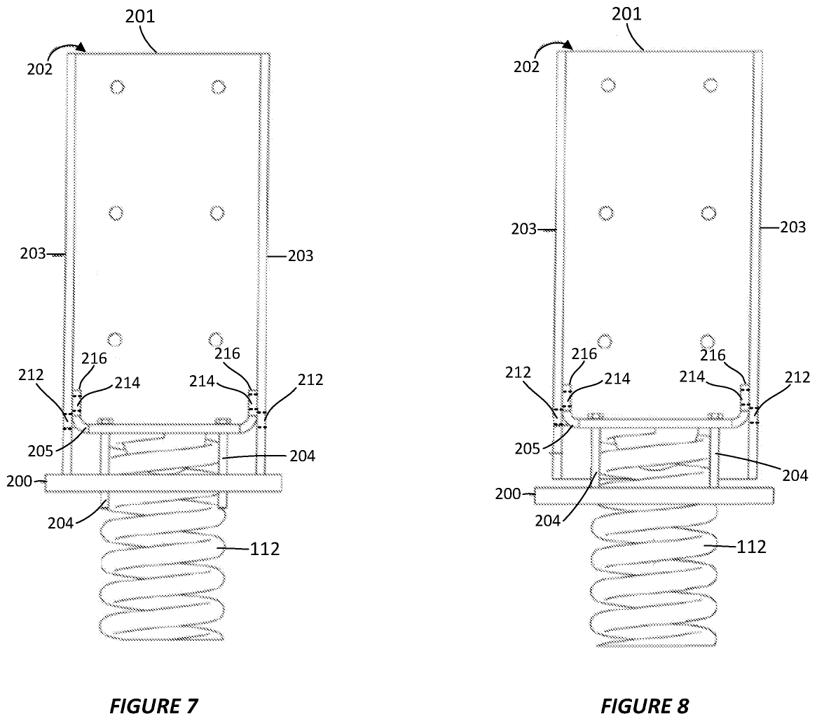

Referring to FIG. 7, the operator may then gradually unthread the connectors 204 evenly from the exchanging plate 200 to increase the length of the portions of the connectors that separate the exchanging plate and the contact plate 205. As that length increases, the compliant member 112 slowly expands and decompresses, which raises the contact plate 205 between the side stiffeners 203, as evidenced by the mis-alignment of opening 212 with opening 214. Unthreading the connectors 204 from the exchanging plate 200 transfers the potential energy in the compliant member 112 being exchanged to the remaining compliant members 112 that support the screen frame 104. In other words, the weight of the screen frame 104 bearing on the compliant member 112 that is being removed is transferred to the other compliant members.

As the weight of the screen frame 104 is transferred, the remaining compliant members 112 temporarily experience a greater compressive force and the equilibrium point of the screen assembly is lowered slightly as the compliant members compress further under the added weight. Once the compliant member 112 is fully decompressed, as shown in FIG. 8, the connectors 204 are loosened further. As the connectors 204 unthread from the exchanging plate 200, the exchanging plates 200 are brought out of contact with the bottom of the bracket assembly 202. It is not necessary to fully decompress the compliant member 112 or to loosen connector 204 until exchanging plate 200 separates from bracket assembly 202. The compliant member 112 could be removed from the bracket assembly 202 even while it is under compression. However, the separation of the exchanging plate 200 from the bracket assembly 202 is a safety assurance feature of the invention. Once this separation occurs, the operator can be assured that compliant member 112 has been fully decompressed and can be safely removed.

In order for the new compliant member 112 to be installed, the above-described process is reversed. Once the new compliant member 112 has been correctly positioned below the contact plate 205, a portion of the potential energy stored in each of the remaining compliant members can be transferred to the replacement compliant member. The connectors 204 associated with the replacement compliant member 112 are gradually tightened until holes 212, 214 are aligned. This tightening process transfers potential energy from the other compliant members 112 to the new, replacement compliant member. At that point, fasteners 210 are re-inserted through openings 212, 214 and tightened in order to re-connect the contact plate 205 with the bracket assemblies 202. Connector 204 may then be loosened entirely and removed from contact plate 205 and bracket assemblies 202. Lastly, exchanging plates 200 may be removed, which returns compliant member 112 and screen frame 104 to regular operation.

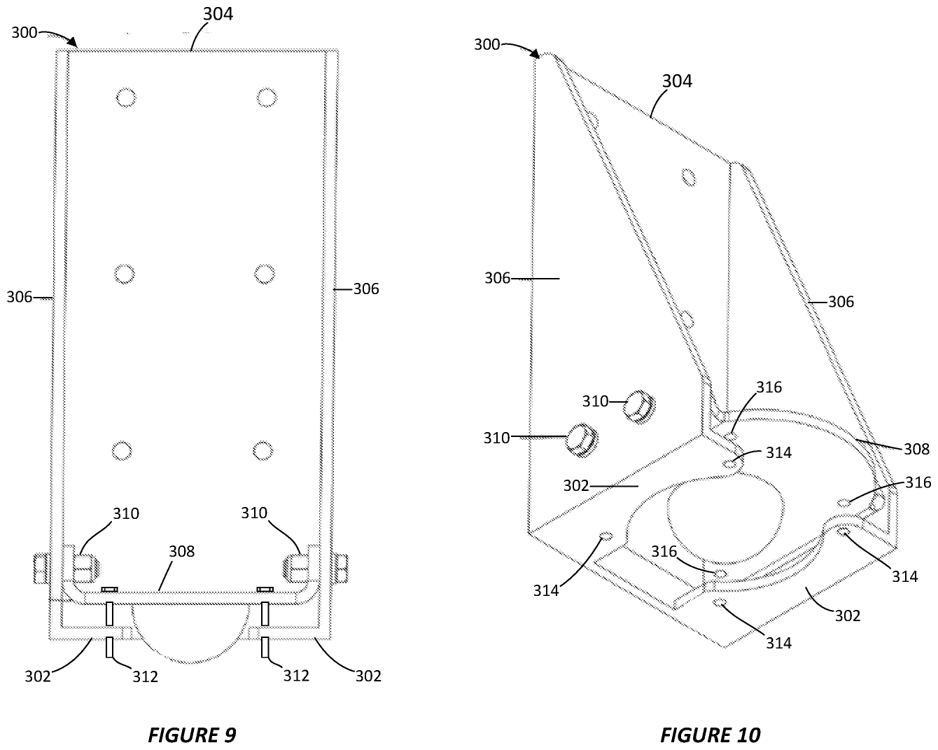

With reference now to FIGS. 9 and 10, there is provided bracket assemblies 300 that include integrated exchanging plates 302 according to an alternative embodiment of the present invention. Bracket assembly 300 includes back plate 304 and a pair of side stiffeners 306 that are attached to the back plate, and contact plate 308 that is removably attached to and between the side stiffeners 306 by fasteners 310. In this particular embodiment, integrated exchanging plates 302 are mounted to and extend inwards (i.e., towards each other) from a bottom end of the bracket assembly 300. When replacing compliant member 112, connectors 312 are inserted through openings 314 in exchanging plates 302 and corresponding openings 316 in contact plate 308 in order to fix the distance between the contact plate and the exchanging plate. When the distance between contact plate 302 and exchanging plate 302 is fixed, the fasteners 210 can be safely removed from side stiffeners 306 in a similar manner as discussed above.

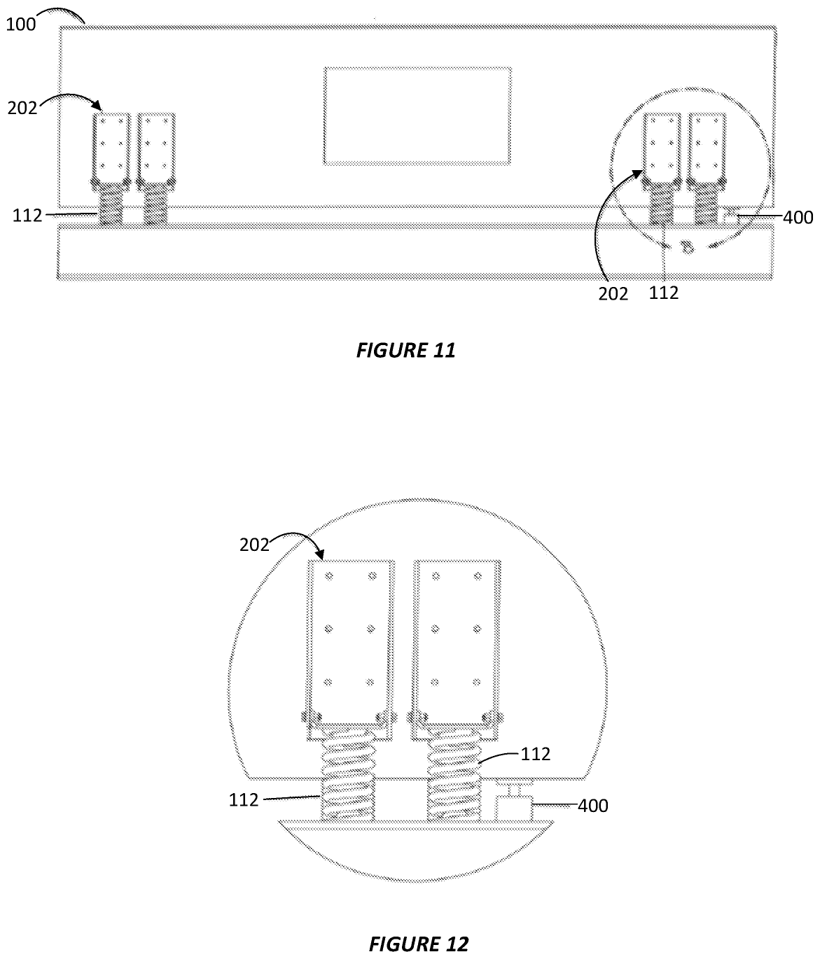

An alternative embodiment is illustrated in FIGS. 11 and 12. This embodiment employs height retention device 400 in conjunction with bracket assembly 202 (or 300) and to permit the exchange of compliant members without transferring potential energy to other compliant members 112. The height retention device 400 is positioned below the screen frame 104 and maintains the equilibrium height of the screen frame 104 while the compliant member 112 is exchanged utilizing the same process as described previously. The height retention device 400 may take the form of a hydraulic jack or block which is used to maintain the equilibrium height of the screen frame 104, but not to raise the screen assembly.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. An apparatus for use in replacing a compliant member of a vibratory screen assembly, wherein the compliant member is compressed between a screen base and a movable contact plate that is mounted on a screen frame of the vibratory screen assembly and potential energy is stored by the compliant member as a result of the compression, the apparatus comprising:
an exchanging plate; and
one or more connectors configured to connect the exchanging plate to the contact plate and to hold the exchanging plate at a selectively adjustable distance away from the contact plate, wherein the potential energy stored by the compliant member may be increased by decreasing said distance and the potential energy stored by the compliant member may be decreased by increasing said distance.

2. The apparatus of claim 1 further comprising a height retention device positioned under the screen frame configured to maintain the vertical position of the screen frame with respect to the screen base as said distance between the contact plate and the exchanging plate is increased.

3. The apparatus of claim 1 wherein each of the one or more connectors comprises a bolt having a threaded end and a corresponding nut configured to thread onto the threaded end, the bolt sized to pass through corresponding aligned openings formed in the contact plate and the exchanging plate.

4. The apparatus of claim 1 further comprising:
a bracket assembly having:
a back plate configured to mount to said screen frame;
a pair of side stiffeners mounted to and extending outwards from the back plate;
a vertical slot defined by the back plate and the side stiffeners;
said movable contact plate, which is configured to slide vertically upwards and downwards within the vertical slot and to be fixedly mounted between the side stiffeners at a selected vertical position in the vertical slot;
a pair of exchanging plates positioned between the contact plate and the screen base, each of which exchanging plates has an inner face; and
an open area formed between the inner faces of the exchanging plates that is sized to allow the compliant member to extend from the screen base, through the open area, and to contact the contact plate.

5. The apparatus of claim 4 wherein the exchanging plates are fixedly mounted to the side stiffeners and extend inwards towards the compliant member.

6. The apparatus of claim 4 wherein the exchanging plates are movable vertically upwards and downwards with respect to the bracket assembly and are guided vertically by the one or more connectors and each exchanging plate is configured to removably engage at least one side stiffener and, through that engagement, to be prevented from moving further vertically upwards.

7. The apparatus of claim 6 wherein each exchanging plate is configured to engage both side stiffeners.

8. The apparatus of claim 4 further comprising fasteners configured to engage both the side stiffeners and the contact plate in order to fix the contact plate at said selected vertical position.

9. The apparatus of claim 8 further comprising vertically disposed left and right ends formed on the contact plate that are each disposed adjacent an inner surface of one of the side stiffeners and are each engaged by at least one of said fasteners for fixing the contact plate at the selected vertical position.

10. A screen assembly system comprising:
a vibratory screen assembly configured to classify and separate material into two or more differently-sized products based on the size of the material, said vibratory screen assembly comprising a screen frame and a screen base;
a plurality of bracket assemblies mounted to the screen frame of the vibratory screen assembly, each bracket assembly including:
a movable contact plate; and
a compliant member configured to compress between the screen base upon which the screen frame is supported and the movable contact plate when supporting the screen frame and to store potential energy as a result of that compression;
one or more exchanging plates; and
connectors configured to connect the one or more exchanging plates to a contact plate of a selected one of the plurality of bracket assemblies and to hold the one or more exchanging plate at a selectively adjustable distance away from the contact plate, wherein the potential energy stored by the compliant member may be increased by decreasing said distance, which reduces the potential energy stored in the other compliant members, and the potential energy stored by the compliant member may be decreased by increasing said distance, which increases the potential energy stored in the other compliant members,
wherein the bracket assemblies are arranged and configured such that, after the potential energy stored in the compliant member of the selected bracket assembly is decreased entirely, the vibratory screen assembly can be temporarily entirely supported by one less than the plurality of bracket assemblies, so that the compliant member can be removed and replaced.

11. The system of claim 10, the screen assembly comprising:
one or more screen decks, each screen deck having a sizing medium; and
the screen frame, including a pair of side plates, each of which has an outwardly-facing surface and an inwardly-facing surface and wherein each of the bracket assemblies is mounted to the outwardly-facing surface of one of the side plates and the one or more screen decks are disposed adjacent the inwardly-facing surface of the side plates.

12. The system of claim 11 wherein the one or more exchanging plates are sized to fit between the compliant members of the plurality of bracket assemblies and the outwardly-facing surface of the side plates.

13. The system of claim 10 wherein each bracket assembly further comprises:
a back plate configured to mount to said screen frame;
a pair of side stiffeners mounted to and extending outwards from the back plate;
a vertical slot defined by the back plate and the side stiffeners, wherein said movable contact plate is configured to slide vertically upwards and downwards within the vertical slot and to be fixedly mounted between the side stiffeners at a selected vertical position in the vertical slot; and
a pair of exchanging plates each having an inner face, wherein each exchanging plate is positioned between the contact plate and the screen base;
an open area formed between the inner faces of the exchanging plates that is sized to allow the compliant member to extend from the base surface, through the open area, and to contact the contact plate.

14. The system of claim 13 wherein the compliant member has a substantially circular cross-section having a radius.

15. The system of claim 14 wherein the compliant member is a helical spring.

16. The system of claim 14 wherein the exchanging plates extend inwards towards a vertical center of the back plate and terminate at an inner face having a radius.

17. The system of claim 16 wherein the radius of the inner face is greater than the radius of the compliant member.

18. A method for removing a compliant member from a vibratory screen assembly comprising a screen frame that is vibrationally isolated from a screen base by a plurality of compliant members, the method comprising the steps of:
A. providing the vibratory screen assembly with a plurality of bracket assemblies, one for each compliant member;
B. connecting a movable contact plate to each bracket assembly at a selected vertical position such that the contact plate is prevented from moving vertically;
C. supporting the vibratory screen frame above the base screen by compressing the plurality of compliant members between the screen base and each of the contact plates, wherein potential energy stored by the compressed compliant members is equivalent to the weight of the screen frame such that the screen frame is located at a first equilibrium vertical position with respect to the screen base;
D. removably connecting an exchange plate to a selected one of the contact plates at a selectively adjustable distance via one or more connectors;
E. disconnecting the selected one of the contact plates from the bracket assembly such that the contact plate can move vertically;
F increasing the distance between the exchange plate and the selected one of the plates until the compliant member is decompressed;
G. removing the decompressed compliant member from between the screen base and the selected one of the contact plates; and
H. supporting the vibratory screen assembly above the screen base by compressing the remaining compliant members between the screen base and the contact plates which are contacted by the remaining compliant members, wherein potential energy stored by the remaining compressed compliant members is equivalent to the weight of the screen frame such that the screen frame is located at a second equilibrium vertical position with respect to the screen frame that is different from the first equilibrium vertical position.

19. The method of claim 18 further comprising the steps of:
I. placing an uncompressed compliant member between the screen base and a selected one of the contact plates; and
J. reducing the distance between the exchange plate and the selected one of the contact plates to compress the uncompressed compliant member.

20. The method of claim 19 wherein the distance between the exchange plate and the selected one of the contact plates is reduced until the screen assembly is located at the first equilibrium vertical position.
